(19) United States
(12) Patent Application Publication
(10) Pub. No.: US 2026/0025030 A1
(43) Pub. Date: Jan. 22, 2026

(54) STATOR, MOTOR, AND METHOD FOR MANUFACTURING STATOR

(71) Applicant: NIDEC CORPORATION, Kyoto (JP)

(72) Inventors: Sakae NOGAMI, Kyoto (JP); Nobuaki YASUMOTO, Kyoto (JP); Yuta YAMASAKI, Kyoto (JP); Toshihiro KAWAHARA, Kyoto (JP)

(21) Appl. No.: 19/339,685

(22) Filed: Sep. 25, 2025

Related U.S. Application Data
(63) Continuation of application No. PCT/JP2024/011745, filed on Mar. 25, 2024.

(30) Foreign Application Priority Data
Mar. 31, 2023 (JP) 2023-058902

(51) Int. Cl. H02K 1/16; H02K 3/32; H02K 15/026; H02K 15/123

(52) U.S. Cl. CPC H02K 1/16; H02K 3/32; H02K 15/026; H02K 15/123; H02K 2203/03

(57) ABSTRACT

A stator includes a stator core having an annular shape surrounding a center axis extending in an axial direction, a plurality of coil portions, a circuit board, and a coating portion having electrical insulating properties. The stator core includes a slot. A plurality of the slots extend through the stator core in the axial direction and are arranged in a circumferential direction. The plurality of coil portions are respectively provided in the plurality of slots. The circuit board is on one side of the stator core in the axial direction and electrically connected to a lead wire drawn from the plurality of coil portions. The coating portion coats at least the coil portions. The circuit board includes a first through-hole extending in the axial direction. At least a portion of the first through-hole overlaps the stator core as viewed in the axial direction.

### CROSS-REFERENCE TO RELATED APPLICATIONS

This application is a continuation of International Application No. PCT/JP2024/011745, filed on Mar. 25, 2024, which claims priority to Japanese Patent Application No. 2023-058902, filed on Mar. 31, 2023, the entire contents of which applications are incorporated herein by reference.

### 1. FIELD OF THE INVENTION

The present disclosure relates to stators, motors, and methods for manufacturing stators.

### 2. BACKGROUND

There has been known a motor including a stator having waterproofing properties enhanced by surface coating. For example, a stator assembly component is provided in an accommodating space of a cover. A circuit board is loosely inserted into an opening portion of the cover. To form the stator assembly component having waterproofing effects, an area between the accommodating space of the cover and the stator assembly component is filled with a filler through a gap between the cover and the circuit board, and the filler is subjected to a solidification treatment.

However, the gap between the cover and the circuit board is narrow, making it difficult to fill the gap with the filler. Further, the filler is poured from a location outward in a radial direction away from the accommodating space, making it difficult to densely fill the accommodating space with the filler. As a result, the possibility exists that a gap not filled with the filler is formed in the accommodating space. Such a gap can readily become a pathway for water and other substances entering from the outside, which may reduce electrical insulation properties of the surface of the stator due to this entry.

### SUMMARY

A stator according to a first example embodiment of the present disclosure includes a stator core having an annular shape surrounding a center axis extending in an axial direction, a plurality of coil portions, a circuit board, and a coating portion having electrical insulating properties. The stator core includes a slot. A plurality of the slots extend through the stator core in the axial direction and are arranged in a circumferential direction. The plurality of coil portions are respectively provided in the plurality of slots. The circuit board is on one side of the stator core in the axial direction and electrically connected to a lead wire drawn from the plurality of coil portions. The coating portion coats at least the coil portions. The circuit board includes a first through-hole extending in the axial direction. At least a portion of the first through-hole overlaps the stator core as viewed in the axial direction.

Alternatively, a stator according to a second example embodiment of the present disclosure includes a stator core, a plurality of coil portions, a coating portion having electrical insulation properties, and a cover portion. The stator core has an annular shape surrounding a center axis extending in an axial direction and includes a plurality of slots extending through the stator core in the axial direction and arranged in a circumferential direction. The plurality of coil portions are respectively provided in the plurality of slots. The coating portion coats at least the coil portions. The cover portion accommodates a stator assembly including the stator core and the plurality of coil portions. The cover portion has a lidded tubular shape that opens toward one side in the axial direction. A second through-hole extending in the axial direction is provided in a lid portion of the cover portion. At least a portion of the second through-hole overlaps the stator core as viewed in the axial direction.

Further, an illustrative motor according to the present disclosure includes the stator according to one of the example embodiments described above and a rotor configured to be rotatable about the center axis.

Further, an example Further, embodiment of a method for manufacturing a stator according to the present disclosure is a method for manufacturing the stator according to the example embodiments described above. The method includes providing the circuit board such that at least a portion of the first through-hole overlaps the stator core as viewed in the axial direction and forming the coating portion by utilizing the first through-hole.

Alternatively, an example embodiment of a method for manufacturing a stator according to the present disclosure is a method for manufacturing the stator which includes the steps of locating the cover portion such that at least a portion of the second through-hole overlaps the stator core as viewed in the axial direction and forming the coating portion by utilizing the second through-hole.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of a motor according to an example embodiment of the present disclosure.

FIG. 2 is a plan view of the motor on one axial direction side.

FIG. 3 is a view illustrating an assembly example of a stator assembly according to an example embodiment of the present disclosure.

FIG. 4 is a view illustrating an attachment example of a cover portion according to an example embodiment of the present disclosure.

FIG. 5A is a view illustrating a filling example of a coating portion according to an example embodiment of the present disclosure before curing.

FIG. 5B is a view illustrating another filling example of the coating portion before curing.

FIG. 6 is a flowchart explaining an example of a method for manufacturing a stator according to an example embodiment of the present disclosure.

FIG. 7 is a cross-sectional view of the motor according to a modification of an example embodiment of the present disclosure.

FIG. 8A is a view illustrating a filling example of the coating portion before curing in the modification.

FIG. 8B is a view illustrating another filling example of the coating portion before curing in the modification.

FIG. 9 is a flowchart explaining an example of the method for manufacturing a stator according to the modification.

### DETAILED DESCRIPTION

Hereinafter, example embodiments will be described with reference to the drawings.

Note that, in the present specification, in a motor 100, a direction parallel to a center axis CA is referred to as an “axial direction.” In the axial direction, an orientation from a stator core 11 described below toward a circuit board 15 is referred to as “one axial direction Da,” and an orientation from the circuit board 15 toward the stator core 11 is referred to as “the other axial direction Db.” Further, in each constituent element, in the axial direction, a direction from a center portion of the constituent element in the axial direction toward an end portion of the constituent element in the axial direction may be referred to as “outward in the axial direction,” and a direction from the end portion of the constituent element in the axial direction toward the center portion of the constituent element in the axial direction may be referred to as “inward in the axial direction.”

Further, in the motor 100, a direction orthogonal to the center axis CA is referred to as a “radial direction,” and a direction of rotation about the center axis CA is referred to as a “circumferential direction.” In the radial direction, an orientation toward the center axis CA is referred to as “inward in the radial direction,” and an orientation away from the center axis CA is referred to as “outward in the radial direction.”

Further, in the present specification, an “annular shape” includes not only a shape continuously connected without breaks across the entire region in the circumferential direction about the center axis CA, but also a shape having one or more breaks in part of the entire region in the circumferential direction about the center axis CA. Further, an “annular shape” also includes a shape having a closed curve on a curved surface intersecting the center axis CA about the center axis CA.

Further, in a positional relationship between any one and any other of an azimuth, a line, and a plane, “parallel” includes not only a state in which the two do not intersect at all no matter how far each extends, but also a state in which the two are substantially parallel. Further, each of “perpendicular” and “orthogonal” includes not only a state in which the two intersect each other at 90 degrees, but also a state in which the two are substantially perpendicular and a state in which the two are substantially orthogonal. That is, each of “parallel,” “perpendicular,” and “orthogonal” includes a state in which the positional relationship between the two permits an angular deviation to an extent not departing from the spirit of the present disclosure.

Note that these terms are merely used for description and are not intended to limit actual positional relationships, directions, names, and the like.

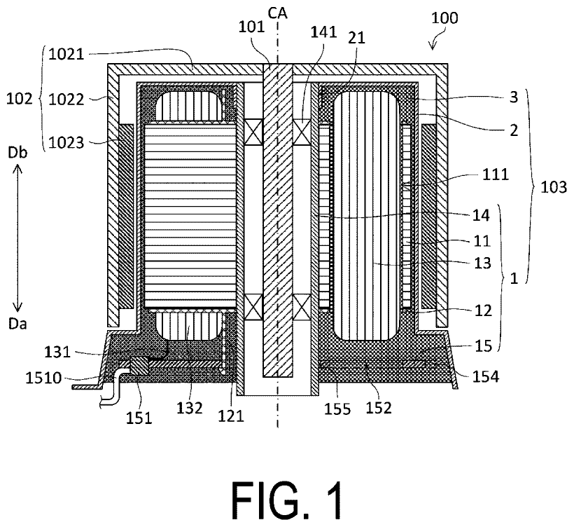

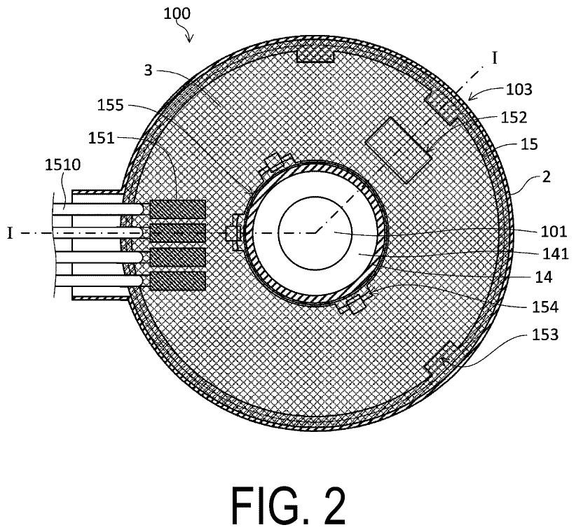

FIG. 1 is a cross-sectional view of the motor 100 according to an example embodiment. FIG. 2 is a plan view of the motor 100 on the one axial direction Da side. Note that FIG. 1 illustrates a cross-sectional structure of the motor 100 taken along a dashed line I-I in FIG. 2. Further, FIG. 2 illustrates a coating portion 3 described below by semi-transparent hatching.

As illustrated in FIG. 1, the motor 100 includes a shaft 101, a rotor 102, and a stator 103. In the motor 100, as described below, it is possible to improve a filling efficiency of the coating portion 3 having electrical insulation properties and used to coat at least a coil portion 13 and improve electrical insulation properties of a surface of the stator 103 (coil portion 13, in particular).

The shaft 101 extends in the axial direction along the center axis CA and is rotatable about the center axis CA together with the rotor 102. That is, in the present example embodiment, the shaft 101 is a rotating shaft. However, the shaft 101 is not limited to this example, and may be a fixed shaft fixed together with the stator 103, or may be non-rotatable about the center axis CA. In the case of a fixed shaft, a bearing that rotatably supports the rotor 102 relative to the shaft 101 is disposed between the shaft 101 and the rotor 102.

The rotor 102 is rotatable about the center axis CA. The rotor 102 has a lidded tubular shape and is fixed to an end portion of the shaft 101 in the axial direction in the present example embodiment. As illustrated in FIG. 1, the rotor 102 includes a lid portion 1021, a tubular portion 1022, and a magnet 1023. The lid portion 1021 extends outward from the shaft 101 in the radial direction. The tubular portion 1022 extends in the one axial direction Da from an outer end portion of the lid portion 1021 in the radial direction and surrounds part of the stator 103 (stator core 11 and coil portion 13, for example). The magnet 1023 is disposed on an inner surface of the tubular portion 1022 in the radial direction. In the magnet 1023, a plurality of different magnetic poles are alternately arranged in the circumferential direction. Note that, in FIG. 1, the magnet 1023 is directly fixed to the inner surface of the tubular portion 1022 in the radial direction. However, the configuration is not limited to this example, and the magnet 1023 may be fixed to the inner surface of the tubular portion 1022 in the radial direction with a yoke, which is a magnetic body, extending in the axial direction and the circumferential direction interposed therebetween.

The stator 103 rotates the rotor 102 by a magnetic flux generated by energization. As illustrated in FIG. 1 and FIG. 2, the stator 103 includes a stator assembly 1, a cover portion 2, and the coating portion 3.

The stator assembly 1 includes the stator core 11, an insulator 12, a plurality of the coil portions 13, a holder 14, and the circuit board 15.

The stator core 11 has an annular shape surrounding the center axis CA. The stator 103 includes the stator core 11. The stator core 11 is a magnetic body and, in the present example embodiment, is a layered body in which electromagnetic steel plates having a plate shape and extending in the radial direction are layered in the axial direction. The stator core 11 is fixed to an outer surface of the holder 14 in the radial direction and faces the magnet 1023 in the radial direction. Further, the stator core 11 includes a slot 111. A plurality of the slots 111 extend through the stator core 11 in the axial direction and are arranged in the circumferential direction.

The insulator 12 has electrical insulation properties and is disposed on a surface of the stator core 11 (both end surfaces in the axial direction, inner surfaces of the slots 111, and the like, in particular).

The coil portions 13 are respectively provided in the slots 111. The stator 103 includes the plurality of coil portions 13. In other words, each of the coil portions 13 is a member in which a conductive wire (reference sign omitted) is provided in a coil shape on the stator core 11 with the insulator 12 interposed therebetween. Note that the conductive wire is, for example, an enamel-coated copper wire or a metal wire coated with an electrical insulating member, and is wound around the stator core 11 to form the coil portions 13. The plurality of coil portions 13 are arranged in the circumferential direction. When a drive current is supplied to each coil portion 13, the stator 103 is excited and drives the rotor 102.

The holder 14 has a tubular shape surrounding the center axis CA and extending in the axial direction, and holds the stator core 11 on the outer surface thereof in the radial direction. The stator 103 includes the holder 14. Further, a bearing 141 is disposed on an inner circumferential surface of the holder 14, and the shaft 101 is inserted therethrough. In the present example embodiment, the holder 14 rotatably supports the shaft 101 with the bearing 141 inserted therebetween. Note that the bearing 141 may be a rolling bearing such as a ball bearing, or may be a sliding bearing.

The circuit board 15 is provided in the one axial direction Da from the stator core 11, the coil portions 13, and the like, and is electrically connected to a lead wire 131 drawn from the coil portions 13. The stator 103 includes the circuit board 15. Note that the lead wire 131 is, for example, an end portion of the conductive wire constituting the coil portions 13. A drive circuit of the stator 103 and the like are mounted onto the circuit board 15. The circuit board 15 is supported by a support member 121. The support member 121 extends in the one axial direction Da from the insulator 12 disposed on the one end surface of the stator core 11 in the axial direction.

The circuit board 15 includes a connector portion 151. The connector portion 151 is connected to a connection wire of at least one of the lead wire 131 and an external wiring line 1510. The external wiring line 1510 electrically connects the circuit board 15 to a device or the like outside the motor 100. That is, the external wiring line 1510 is a connection wire drawn from the circuit board 15 to outside the motor 100, and is connected to an external device or the like.

Further, the circuit board 15 further includes a first through-hole 152 extending in the axial direction. At least part of the first through-hole 152 overlaps the stator core 11 in the axial direction. In other words, at least part of the first through-hole 152 overlaps the stator core 11 as viewed in the axial direction. Note that the first through-hole 152 viewed from the axial direction has a rectangular shape in FIG. 2, but is not limited to this example, and need not be rectangular. For example, the first through-hole 152 viewed in the axial direction may have a polygonal shape other than a rectangular shape, or may have a circular shape including a perfect circle and an ellipse, an arc shape, or the like. Further, the first through-hole 152 may have a notch shape formed at an inner end portion in the radial direction or an outer end portion in the radial direction of the circuit board 15. Preferably, a cross-sectional area of the first through-hole 152 as viewed in the axial direction is equal to or greater than 1 mm². Alternatively, a hole diameter of the first through-hole 152 is equal to or greater than 1 mm.

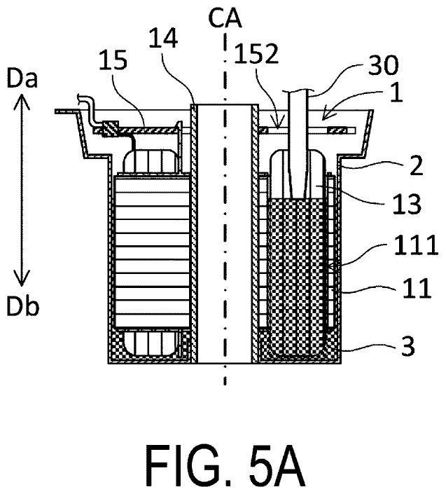

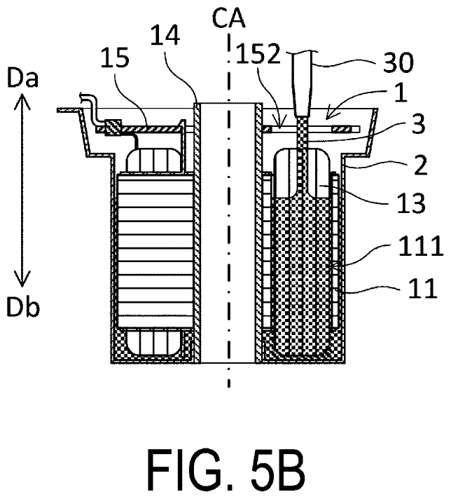

With this configuration, by utilizing the first through-hole 152, it is possible to densely dispose the coating portion 3 in a space where the coating portion 3 is to be disposed, such as surfaces of the coil portions 13. For example, the coating portion 3 before curing has fluidity. The space described above can be readily and better filled with the coating portion 3 without gaps by inserting an injection nozzle into the first through-hole 152 and injecting the coating portion 3 before curing (refer to FIG. 5A described below) or pouring the coating portion 3 before curing into the first through-hole 152 (refer to FIG. 5B described below). At this time, air pushed out by the filling performed with the coating portion 3 can be further discharged outside the stator 103 through the first through-hole 152. Then, the coating portion 3 is cured, making it possible to dispose the coating portion 3 in the space described above. This makes it possible to improve the filling efficiency of the coating portion 3 before curing and improve the electrical insulation properties of the surface of the stator 103 (coil portions 13, in particular) by the coating portion 3 after curing. This also makes it possible to improve dust-proofing properties and waterproofing properties with respect to entry of dust and liquid such as water.

Preferably, at least part of the first through-hole 152 overlaps at least part of the slots 111 in the axial direction. In other words, at least part of the first through-hole 152 overlaps at least part of the slots 111 as viewed in the axial direction. With this configuration, the coating portion 3 is readily provided in the slots 111 in which the coil portions 13 are disposed. Accordingly, the coil portions 13 can be readily covered with the coating portion 3. However, this example does not exclude a configuration in which the first through-hole 152 does not overlap the slots 111 at all as viewed in the axial direction.

Further, preferably, the first through-hole 152 is disposed at a location away from the connector portion 151. For example, in the circumferential direction relative to the center axis CA, a minimum interval in the circumferential direction between the connector portion 151 and the first through-hole 152 is 45° or greater. With this configuration, for example, a flow of the coating portion 3 before curing and with which filling is to be performed is less likely to be obstructed by at least one of the connection wires described above (that is, lead wire 131 and external wiring line 1510). This makes it possible to suppress or prevent a decrease in the filling efficiency of the coating portion 3 before curing and densely dispose the coating portion 3 even near the connector portion 151. However, this example does not exclude a configuration in which the first through-hole 152 is disposed near the connector portion 151. For example, in the circumferential direction relative to the center axis CA, the minimum interval in the circumferential direction between the connector portion 151 and the first through-hole 152 may be less than 45°.

Further, preferably, the circuit board 15 further includes a first recess portion 153 and a second recess portion 154.

The first recess portion 153 is recessed inward in the radial direction at the outer end portion of the circuit board 15 in the radial direction. The first recess portion 153 may be singular, or may be plural and arranged in the circumferential direction. In the latter case, although the number of the first recess portions 153 is three in FIG. 2, the number is not limited to this example and may be a plurality other than three.

The second recess portion 154 is recessed outward in the radial direction at the inner end portion of the circuit board 15 in the radial direction. The second recess portion 154 may be singular, or may be plural and arranged in the circumferential direction. In the latter case, although the number of the second recess portions 154 is three in FIG. 2, the number is not limited to this example and may be a plurality other than three.

Note that, in FIG. 2, each of the first recess portion 153 and the second recess portion 154 has a rectangular shape as viewed in the axial direction. However, the shape of at least one of the first recess portion 153 or the second recess portion 154 is not limited to this example, and may be a polygonal shape other than a rectangular shape or an arc shape including a semicircle and the like.

Further, without limitation to the example in FIG. 2, one of the first recess portion 153 or the second recess portion 154 may be omitted. That is, preferably, the circuit board 15 has at least one of the first recess portion 153 or the second recess portion 154.

With this configuration, when filling is performed with the coating portion 3 before curing, the air between the stator assembly 1 and the cover portion 2 can be further discharged through at least one of the recess portions described above. Accordingly, the area between the stator assembly 1 and the cover portion 2 is readily filled with the coating portion 3 without gaps, that is, the filling efficiency can be improved. This makes it possible to further improve the electrical insulation properties of the surface of the stator 103. However, the example described above does not exclude a configuration in which the circuit board 15 includes neither the first recess portion 153 nor the second recess portion 154.

Preferably, the at least one recess portion described above overlaps at least part of the slots 111 in the axial direction. In other words, at least one of the first recess portion 153 or the second recess portion 154 overlaps at least part of the slots 111 as viewed in the axial direction. With this configuration, the air pushed out from the slots 111 by the filling performed with the coating portion 3 before curing is readily discharged outside the stator 103 through at least one of the recess portions described above. Accordingly, the slots 111 in which the coil portions 13 are disposed can be readily filled with the coating portion 3. This makes it possible to readily coat the surfaces of the coil portions 13 with the coating portion 3 without gaps. However, this example does not exclude a configuration in which neither the first recess portion 153 nor the second recess portion 154 overlap at least part of the slots 111 as viewed in the axial direction.

The cover portion 2 has a lidded tubular shape that opens in the one axial direction Da. A center opening 21 through which the holder 14 is inserted is provided in the lid portion of the cover portion 2. As described above, the stator 103 includes the cover portion 2. The cover portion 2 accommodates the stator assembly 1 including the stator core 11, the coil portions 13, the circuit board 15, and the like.

The coating portion 3 coats the stator assembly 1. As described above, the stator 103 includes the coating portion 3 having electrical insulating properties. The coating portion 3 coats at least the coil portions 13 and, in the present example embodiment, covers an outer surface of the stator core 11 in the radial direction, the insulator 12, at least a surface of a coil head 132 of the coil portions 13, the circuit board 15, and the like. Note that the coil head 132 refers to a portion of the coil portions 13 protruding outward from the stator core 11 in the axial direction.

The coating portion 3 is disposed between the stator assembly 1 and the cover portion 2. With this configuration, a surface of the stator assembly 1 can be covered with the cover portion 2 and the coating portion 3. Accordingly, it is possible to prevent dust and liquid such as water from entering the stator 103. This makes it possible to further improve the electrical insulation properties of the surface of the stator assembly 1.

Preferably, the coating portion 3 covers part of the outer surface of the holder 14 in the radial direction (region outward of the stator core 11 in the axial direction, for example). That is, the stator assembly 1 covered with the coating portion 3 includes the holder 14. With this configuration, the coating portion 3 can be disposed between the holder 14 and the cover portion 2. The surface of the stator assembly 1 including the outer surface of the holder 14 can be covered with the coating portion 3 and the cover portion 2, making it possible to prevent dust and liquid such as water from entering the stator 103 from locations such as the outer surface of the holder 14 and a connection portion with another member (stator core 11, for example), and further improve the electrical insulation properties of the surface of the stator assembly 1. However, this example does not exclude a configuration in which the coating portion 3 does not cover the holder 14.

Further, preferably, the coating portion 3 further covers a surface of the circuit board 15 (and circuits, devices, wiring lines, and the like mounted onto the circuit board 15). With this configuration, it is possible to prevent dust and liquid such as water from adhering to the circuit board 15 (circuits, devices, wiring lines, and the like mounted onto the circuit board 15, in particular) by the coating with the coating portion 3. Accordingly, the electrical insulation properties of the surface of the circuit board 15 can be improved.

At this time, more preferably, the coating portion 3 is provided in the first through-hole 152. In other words, the coating portion 3 is also provided inside the first through-hole 152, closing the first through-hole 152. More preferably, the coating portion 3 covers one end portion of the first through-hole 152 in the axial direction. With this configuration, it is possible to prevent dust and liquid such as water from entering the other axial direction Db side of the circuit board 15 through the first through-hole 152.

However, the configuration described above does not exclude a configuration in which the coating portion 3 does not cover the surface of the circuit board 15 or a configuration in which the coating portion 3 is not provided in the first through-hole 152.

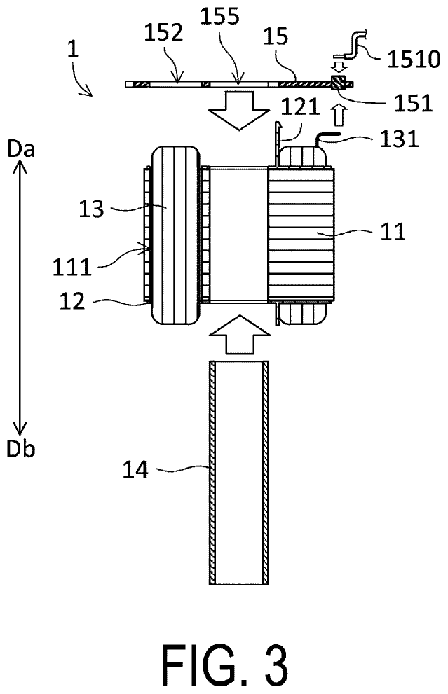

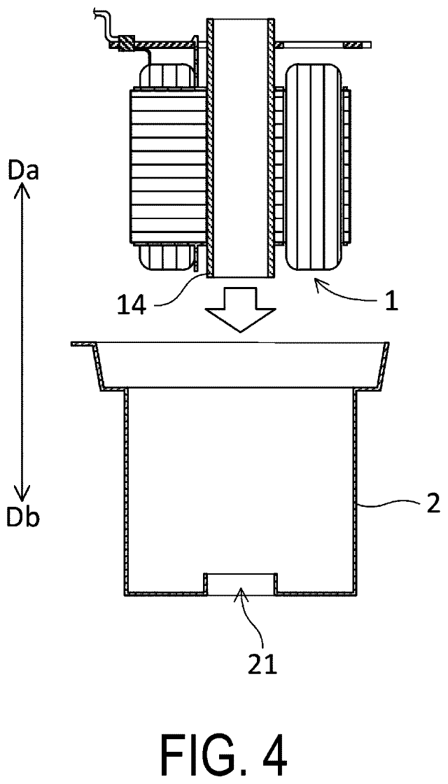

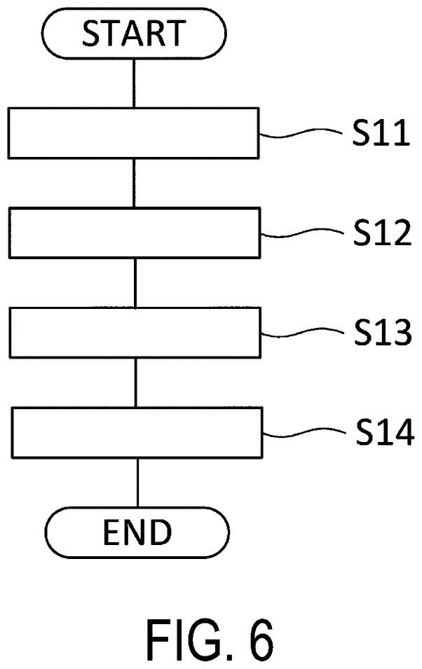

Next, an example of a method for manufacturing the stator 103 will be described with reference to FIG. 3 to FIG. 6. FIG. 3 is a view illustrating an assembly example of the stator assembly 1. FIG. 4 is a view illustrating an attachment example of the cover portion 2. FIG. 5A is a view illustrating a filling example of the coating portion 3 before curing. FIG. 5B is a view illustrating another filling example of the coating portion 3 before curing. FIG. 6 is a flowchart for explaining an example of the method for manufacturing the stator 103. Note that, in FIG. 3 to FIG. 5B, the paper-based orientations of the one axial direction Da and the other axial direction Db are illustrated opposite to those in FIG. 1. Further, in FIG. 5A and FIG. 5B, the coating portion 3 is illustrated by semi-transparent hatching.

First, as illustrated in FIG. 3, the stator assembly 1 is assembled (step S11). For example, a conductive wire is wound around teeth (not illustrated) of the stator core 11 with the insulator 12 interposed therebetween, thereby disposing the coil portions 13 in (the slots 111 of) the stator core 11. Then, an adhesive (not illustrated) is applied to an inner surface of the stator core 11 in the radial direction, and the holder 14 having a tubular shape is inserted into an inner end portion, having a tubular shape, of the stator core 11 in the radial direction. Thus, the stator core 11 is fixed to the outer surface of the holder 14 in the radial direction. Further, the lead wire 131 of the coil portions 13 and the external wiring line 1510 are connected to the connector portion 151 of the circuit board 15, and the circuit board 15 is disposed on the one axial direction Da side of the stator core 11. At this time, the circuit board 15 is supported by the support member 121. Further, the one axial direction Da side of the holder 14 is inserted into a center opening 155 of the circuit board 15. Furthermore, the circuit board 15 is disposed such that at least part of the first through-hole 152 overlaps the stator core 11 (preferably, at least part of any one of the slots 111) as viewed in the axial direction. According to this arrangement, it is possible to improve the filling efficiency of the coating portion 3 before curing and improve the electrical insulation properties of the surface of the stator 103 by the coating portion 3 after curing.

Subsequently, as illustrated in FIG. 4, the stator assembly 1 is accommodated in the cover portion 2 having a lidded tubular shape (step S12). At this time, the other axial direction Db side of the holder 14 is inserted into the center opening 21 of the lid portion of the cover portion 2. Further, an inner end portion of the lid portion in the radial direction abuts against the outer surface of the holder 14 along an edge portion of the center opening 21.

Subsequently, the coating portion 3 is disposed between the stator assembly 1 and the cover portion 2 by utilizing the first through-hole 152 of the circuit board 15 (step S13). This makes it possible to readily fill a space where the coating portion 3 is to be disposed, such as the surfaces of the coil portions 13 provided in the stator core 11, with the coating portion 3. At this time, air pushed out by the filling performed with the coating portion 3 can be further discharged outside the stator 103 through the first through-hole 152. This makes it possible to improve the filling efficiency of the coating portion 3 before curing and improve the electrical insulation properties of the surface of the stator 103 (coil portions 13, in particular) by the coating portion 3 after curing.

For example, as illustrated in FIG. 5A or FIG. 5B, the coating portion 3 before curing is discharged from a distal end (discharge port) of a nozzle 30, and a clearance space between the stator assembly 1 and the cover portion 2 is filled with the coating portion 3 before curing.

In FIG. 5A, when the coating portion 3 is disposed, the nozzle 30 for injecting the coating portion 3 having fluidity is inserted into the first through-hole 152 from the one axial direction Da side of the circuit board 15, and the coating portion 3 is injected. At this time, as illustrated in FIG. 5A, the nozzle 30 may be further inserted into the slot 111 to inject the coating portion 3. With this configuration, the coating portion 3 before curing can be injected in a state in which an injection port of the nozzle 30 inserted into the slot 111 from the one axial direction Da side is disposed further on the other axial direction Db side in the slot 111. This makes it possible to better fill the space to be filled along the surface of the stator 103 (portion on the other axial direction Db side, in particular) with the coating portion 3 before curing without gaps. Thus, the filling efficiency of the coating portion 3 before curing can be further improved. However, the configuration is not limited to this example, and the nozzle 30 need not be inserted into the slot 111.

Further, when the coating portion 3 is injected in FIG. 5A, the nozzle 30 may move in the axial direction (one axial direction Da, in particular) while injecting the coating portion 3. At this time, the nozzle 30 preferably moves in the one axial direction Da, and more preferably moves in the one axial direction Da in accordance with a rise (movement in the one axial direction Da) of an upper surface (one end surface in the axial direction) of the coating portion 3 injected from the nozzle 30. At this time, the injection port of the nozzle 30 may be below (in the other axial direction Db relative to) the upper surface (one end surface in the axial direction) of the coating portion 3, or may be above (in the one axial direction Da relative to) the upper surface (one end surface in the axial direction) of the coating portion 3. With this configuration, the coating portion 3 can be injected while changing the location of the injection port in the axial direction. This makes it possible to implement the injection process of the coating portion 3 by a method more suitable for dense filling with the coating portion 3. Further, by moving the nozzle 30 so that the injection port is continually above (on the one axial direction Da side of) the upper surface (one end surface in the axial direction) of the coating portion 3, it is possible to prevent the coating portion 3 from adhering to the vicinity of the injection port of the nozzle 30. This makes it possible to prevent mixture of the coating portion 3 adhering to the vicinity of the injection port and deteriorated over time with the coating portion 3 newly injected. Further, the nozzle 30 is not pulled out from the coating portion 3 with which filling was performed, making it possible to prevent the generation of air bubbles and the like associated with such pullout.

Alternatively, as illustrated in FIG. 5B, when the coating portion 3 is disposed, the coating portion 3 having fluidity may be poured into the first through-hole 152 from the one axial direction Da side of the circuit board 15. At this time, the nozzle 30 is disposed further in the one axial direction Da than the first through-hole 152 of the circuit board 15. Further, in FIG. 5B as well, when the coating portion 3 is injected, the nozzle 30 may move in the axial direction while injecting the coating portion 3.

With a configuration as in FIG. 5A or FIG. 5B, the coating portion 3 can be readily disposed by utilizing the first through-hole 152.

Note that, when the area between the stator assembly 1 and the cover portion 2 is filled with the coating portion 3, the upper surface (that is, one end surface in the axial direction) of the coating portion 3 before curing is preferably located further in the one axial direction Da than the circuit board 15 (and further in the other axial direction Db than the one end portion of the holder 14 in the axial direction). However, this example does not exclude a configuration in which the upper surface of the coating portion 3 before curing is not located further in the one axial direction Da than the circuit board 15. For example, the location of the upper surface of the coating portion 3 before curing in the axial direction may be the same as that of the circuit board 15, or may be further in the other axial direction Db than the circuit board 15. Note that, in the latter case, the location of the upper surface of the coating portion 3 before curing in the axial direction is further in the one axial direction Da than one end portions of the coil portions 13 in the axial direction.

Subsequently, the stator 103 filled with the coating portion 3 before curing is heated, curing the coating portion 3 (step S14). This ends the processing of FIG. 6.

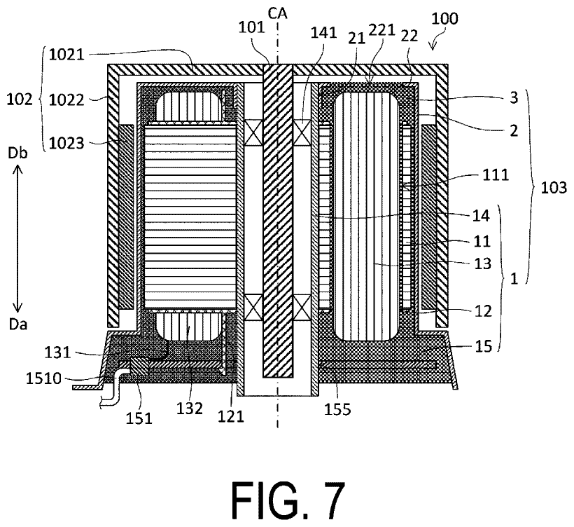

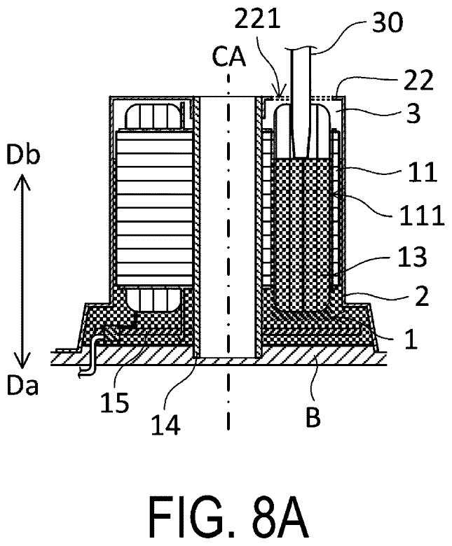

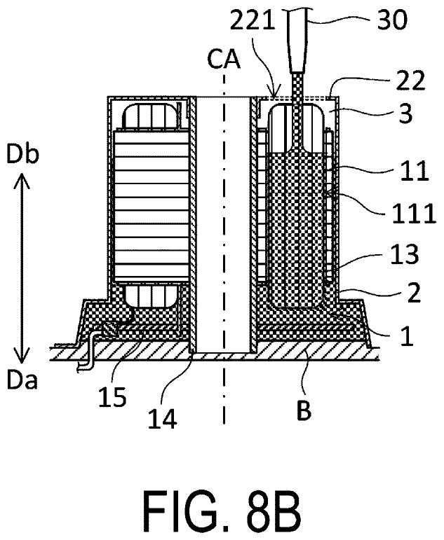

Next, a modification of the example embodiment will be described with reference to FIG. 7 to FIG. 8B. FIG. 7 is a cross-sectional view of the motor 100 according to the modification. FIG. 8A is a view illustrating a filling example of the coating portion 3 before curing in the modification. FIG. 8B is a view illustrating another filling example of the coating portion 3 before curing in the modification. Note that, in FIG. 8A and FIG. 8B, the paper-based orientations of the one axial direction Da and the other axial direction Db are the same as those in FIG. 7. Further, in FIG. 8A and FIG. 8B, the coating portion 3 is illustrated by semi-transparent hatching.

Hereinafter, configurations of the modification that differ from those of the example embodiment described above will be described. Further, constituent elements similar to those of the example embodiment described above are denoted by the same reference signs, and description thereof may be omitted.

In the stator 103 according to the modification, in a lid portion 22 of the cover portion 2, a second through-hole 221 is disposed extending in the axial direction. The cover portion 2 further includes the second through-hole 221. Note that the lid portion 22 extends in a direction (radial direction, for example) intersecting the axial direction. At least part of the second through-hole 221 overlaps the stator core 11 in the axial direction. In other words, at least part of the second through-hole 221 overlaps the stator core 11 as viewed in the axial direction. Note that a shape of the second through-hole 221 viewed in the axial direction may be a polygonal shape such as a rectangular shape, a circular shape including a perfect circle and an ellipse, an arc shape, or the like. Further, in the modification, at least one of the first through-hole 152, the first recess portion 153, or the second recess portion 154 may be provided in the circuit board 15, but may be omitted as illustrated in FIG. 7.

With this configuration, by utilizing the second through-hole 221, it is possible to densely dispose the coating portion 3 in a space where the coating portion 3 is to be disposed, such as the surfaces of the coil portions 13. For example, the coating portion 3 before curing has fluidity. The space described above can be readily and better filled with the coating portion 3 without gaps by inserting the injection nozzle into the second through-hole 221 and injecting the coating portion 3 before curing (refer to FIG. 8A) or pouring the coating portion 3 before curing into the second through-hole 221 (refer to FIG. 8B). At this time, air pushed out by the filling performed with the coating portion 3 can be further discharged outside the stator 103 through the second through-hole 221. Then, the coating portion 3 is cured, making it possible to dispose the coating portion 3 in the space described above. This makes it possible to improve the filling efficiency of the coating portion 3 before curing and improve the electrical insulation properties of the surface of the stator 103 (coil portions 13, in particular) by the coating portion 3 after curing. This also makes it possible to improve the dust-proofing properties and the waterproofing properties with respect to entry of dust and liquid such as water.

Preferably, at least part of the second through-hole 221 overlaps at least part of the slots 111 in the axial direction. In other words, at least part of the second through-hole 221 overlaps at least part of the slots 111 as viewed in the axial direction. With this configuration, the coating portion 3 is readily provided in the slots 111 in which the coil portions 13 are disposed. Accordingly, the coil portions 13 can be readily covered with the coating portion 3. However, this example does not exclude a configuration in which the second through-hole 221 does not overlap the slots 111 at all as viewed in the axial direction.

Preferably, the coating portion 3 is provided in the second through-hole 221. In other words, the coating portion 3 is also provided inside the second through-hole 221, closing the second through-hole 221. More preferably, the coating portion 3 covers one end portion of the second through-hole 221 in the axial direction. With this configuration, it is possible to prevent dust and liquid such as water from entering the cover portion 2 through the second through-hole 221. However, the configuration described above does not exclude a configuration in which the coating portion 3 is not provided in the second through-hole 221.

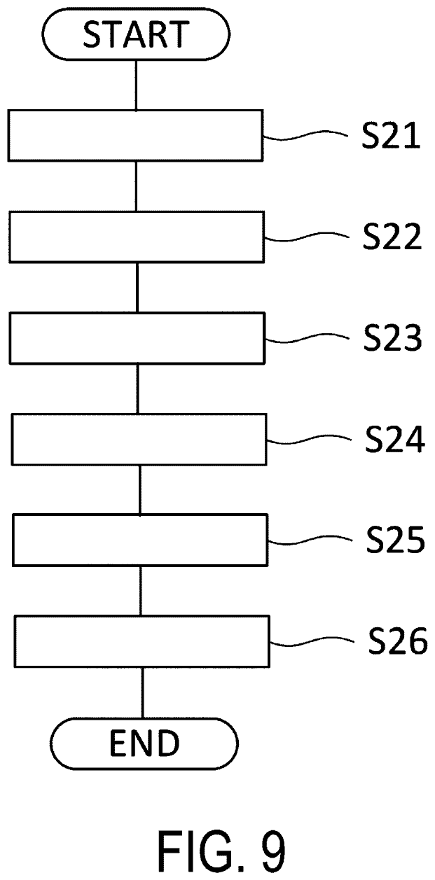

Next, an example of a method for manufacturing the stator 103 according to the modification will be described with reference to FIG. 8A to FIG. 9. FIG. 9 is a flowchart for explaining an example of the method for manufacturing a stator according to the modification.

In FIG. 9, first, as in the example embodiment (refer to FIG. 6), the stator assembly 1 is assembled (step S21). Then, the stator assembly 1 is accommodated in the cover portion 2 having a lidded tubular shape (step S22). At this time, the cover portion 2 is disposed such that at least part of the second through-hole 221 overlaps the stator core 11 (preferably, at least part of any one of the slots 111) as viewed in the axial direction. According to this arrangement, it is possible to improve the filling efficiency of the coating portion 3 before curing and improve the electrical insulation properties of the surface of the stator 103 by the coating portion 3 after curing.

Subsequently, an opening 23 on the one axial direction Da side of the cover portion 2 is covered and closed by a plate-like member B or the like (step S23). This prevents the coating portion 3 before curing that is to be injected into the cover portion 2 from leaking out of the opening 23.

The coating portion 3 is then disposed between the stator assembly 1 and the cover portion 2 by utilizing the second through-hole 221 of the cover portion 2 (step S24). This makes it possible to readily fill a space where the coating portion 3 is to be disposed, such as the surfaces of the coil portions 13 provided in the stator core 11, with the coating portion 3. At this time, air pushed out by the filling performed with the coating portion 3 can be further discharged outside the stator 103 through the second through-hole 221. This makes it possible to improve the filling efficiency of the coating portion 3 before curing and improve the electrical insulation properties of the surface of the stator 103 (coil portions 13, in particular) by the coating portion 3 after curing.

For example, as illustrated in FIG. 8A or FIG. 8B, the coating portion 3 before curing is discharged from the distal end (discharge port) of the nozzle 30, and the clearance space between the stator assembly 1 and the cover portion 2 is filled with the coating portion 3 before curing.

In FIG. 8A, when the coating portion 3 is disposed, the nozzle 30 for injecting the coating portion 3 having fluidity is inserted into the second through-hole 221 from the other axial direction Db side, and the coating portion 3 is injected. At this time, as illustrated in FIG. 8A, the nozzle 30 may be further inserted into the slot 111 to inject the coating portion 3. With this configuration, the coating portion 3 before curing can be injected in a state in which the injection port of the nozzle 30 inserted into the slot 111 from the other axial direction Db side is disposed further on the one axial direction Da side in the slot 111. Accordingly, the space to be filled along the surface of the stator 103 can be better filled with the coating portion 3 before curing without gaps. Thus, the filling efficiency of the coating portion 3 before curing can be further improved. However, the configuration is not limited to this example, and the nozzle 30 need not be inserted into the slot 111.

Further, in FIG. 8A, when the coating portion 3 is injected, the nozzle 30 may move in the axial direction while injecting the coating portion 3. At this time, the nozzle 30 preferably moves in the other axial direction Db, and more preferably moves in the other axial direction Db in accordance with a rise (movement in the other axial direction Db) of the upper surface (one end surface in the axial direction) of the coating portion 3 injected from the nozzle 30. At this time, the injection port of the nozzle 30 may be below (in the one axial direction Da relative to) the upper surface (other end surface in the axial direction) of the coating portion 3, or may be above (in the other axial direction Db relative to) the upper surface (other end surface in the axial direction) of the coating portion 3. With this configuration, the coating portion 3 can be injected while changing the location of the injection port in the axial direction. This makes it possible to implement the injection process of the coating portion 3 by a method more suitable for dense filling with the coating portion 3. Further, by moving the nozzle 30 so that the injection port is continually above (on the other axial direction Db side of) the upper surface (other end surface in the axial direction) of the coating portion 3, it is possible to prevent the coating portion 3 from adhering to the vicinity of the injection port of the nozzle 30. This makes it possible to prevent mixture of the coating portion 3 adhering to the vicinity of the injection port and deteriorated over time with the coating portion 3 newly injected. Further, the nozzle 30 is not pulled out from the coating portion 3 with which filling was performed, making it possible to prevent the generation of air bubbles and the like associated with such pullout.

Alternatively, as illustrated in FIG. 8B, when the coating portion 3 is disposed, the coating portion 3 having fluidity may be poured into the second through-hole 221 from the other axial direction Db side of the cover portion 2. At this time, the nozzle 30 is disposed on the other axial direction Db side of the second through-hole 221 of the lid portion 22. Further, in FIG. 8B as well, when the coating portion 3 is injected, the nozzle 30 may move in the axial direction while injecting the coating portion 3.

With a configuration as in FIG. 8A or FIG. 8B, the coating portion 3 can be readily disposed by utilizing the second through-hole 221.

Subsequently, a posture of the stator 103 is changed so that the opening 23 of the cover portion 2 faces vertically upward, and the plate-like member B closing the opening 23 is removed (step S25). Subsequently, the stator 103 filled with the coating portion 3 before curing is heated, curing the coating portion 3 (step S26). This ends the processing of FIG. 9.

Example embodiments of the present disclosure have been described above. Note that the scope of the present disclosure is not limited to the example embodiments described above. The present disclosure can be implemented by making various modifications to the above-described example embodiments without departing from the spirit of the invention. In addition, the matters described in the above example embodiments can be combined together as desired and appropriate, as long as there is no inconsistency.

The following provides a general description of the example embodiments described above.

For example, a stator disclosed in the present specification includes a stator core having an annular shape surrounding a center axis extending in an axial direction and including a plurality of slots extending through the stator core in the axial direction and arranged in a circumferential direction, a plurality of coil portions respectively provided in the plurality of slots, a circuit board on one side of the stator core in the axial direction and electrically connected to a lead wire drawn from the plurality of coil portions, and a coating portion having electrical insulating properties and coating at least the plurality of coil portions, wherein the circuit board includes a first through-hole extending in the axial direction, and at least a portion of the first through-hole overlaps the stator core as viewed in the axial direction (first configuration).

Note that, in the stator according to the first configuration, at least a portion of the first through-hole may overlap at least a portion of the plurality of slots as viewed in the axial direction (second configuration).

Further, in the stator according to the first or second configuration, the coating portion may be provided in the first through-hole (third configuration).

Further, the stator according to any one of the first to third configurations may further include a cover portion accommodating a stator assembly including the stator core, the plurality of coil portions, and the circuit board, and the coating portion may be between the stator assembly and the cover portion (fourth configuration).

Further, the stator according to the fourth configuration may further include a holder having a tubular shape surrounding the center axis and extending in the axial direction and holding the stator core on an outer surface in a radial direction, and the stator assembly may further include the holder (fifth configuration).

Further, in the stator according to the fourth or fifth configuration, the circuit board may include at least one recess portion of a first recess portion recessed inward in a radial direction at an outer end portion of the circuit board in the radial direction, or a second recess portion recessed outward in the radial direction at an inner end portion of the circuit board in the radial direction (sixth configuration).

Further, in the stator according to the sixth configuration, the at least one recess portion may overlap at least a portion of the plurality of slots as viewed in the axial direction (seventh configuration).

Further, in the stator according to any one of the first to seventh configurations, the coating portion may further cover a surface of the circuit board (eighth configuration).

Further, in the stator according to any one of the first to eighth configurations, the circuit board may include a connector portion connected to at least one connection line of the lead wire or an external wiring line, and in a circumferential direction relative to the center axis, a minimum interval in the circumferential direction between the connector portion and the first through-hole may be about 45° or greater (ninth configuration).

Alternatively, a stator disclosed in the present specification includes a stator core having an annular shape surrounding a center axis extending in an axial direction and including a plurality of slots extending through the stator core in the axial direction and arranged in a circumferential direction, a plurality of coil portions respectively provided in the plurality of slots, a coating portion having electrical insulating properties and coating at least the plurality of coil portions, and a cover portion accommodating a stator assembly including the stator core and the plurality of coil portions, wherein the cover portion has a lidded tubular shape that opens toward one side in the axial direction, a second through-hole extending in the axial direction is provided in a lid portion of the cover portion, and at least a portion of the second through-hole overlaps the stator core as viewed in the axial direction (tenth configuration).

Note that, in the stator according to the tenth configuration, at least a portion of the second through-hole may overlap at least a portion of the plurality of slots as viewed in the axial direction (eleventh configuration).

Further, in the stator according to the tenth or eleventh configuration, the coating portion may be provided in the second through-hole (twelfth configuration).

Further, a motor disclosed in the present specification may include the stator according to any one of the first to twelfth configurations, and a rotor configured to be rotatable about the center axis (thirteenth configuration).

Further, a method for manufacturing a stator disclosed in the present specification is a method for manufacturing the stator according to any one of the first to ninth configurations, the method including the steps of providing the circuit board such that at least a portion of the first through-hole overlaps the stator core as viewed in the axial direction, and forming the coating portion by utilizing the first through-hole (fourteenth configuration).

Further, in the method for manufacturing a stator according to the fourteenth configuration, the step of forming the coating portion may include one of a first step of inserting a nozzle configured to inject the coating portion having fluidity into the first through-hole from one side of the circuit board in the axial direction and injecting the coating portion, or a second step of pouring the coating portion having fluidity into the first through-hole from the one side of the circuit board in the axial direction, and a step of curing the coating portion (fifteenth configuration).

Further, in the method for manufacturing a stator according to the fifteenth configuration, the step of providing the circuit board may include overlapping at least a portion of the first through-hole with the slot as viewed in the axial direction, the step of forming the coating portion may include the first step, and the first step may include further inserting the nozzle into the slot and injecting the coating portion (sixteenth configuration).

Further, in the method for manufacturing a stator according to the fifteenth or sixteenth configuration, the step of forming the coating portion may include the first step, and the first step may include moving, in the axial direction, the nozzle injecting the coating portion (seventeenth configuration).

Further, a method for manufacturing a stator disclosed in the present specification is a method for manufacturing the stator according to any one of the tenth to twelfth configurations, the method including the steps of providing the cover portion such that at least a portion of the second through-hole overlaps the stator core as viewed in the axial direction, and forming the coating portion by utilizing the second through-hole (eighteenth configuration).

Further, in the method for manufacturing a stator according to the eighteenth configuration, the step of forming the coating portion may include one of a third step of inserting a nozzle configured to inject the coating portion having fluidity into the second through-hole from another side in the axial direction and injecting the coating portion, or a fourth step of pouring the coating portion having fluidity into the second through-hole from another side of the cover portion in the axial direction, and a step of curing the coating portion (nineteenth configuration).

Further, in the method for manufacturing a stator according to the nineteenth configuration, the step of providing the cover portion may include overlapping at least a portion of the second through-hole with the slot as viewed in the axial direction, the step of forming the coating portion may include the third step, and the third step may include inserting the nozzle into the slot and injecting the coating portion (twentieth configuration).

Further, in the method for manufacturing a stator according to the nineteenth or twentieth configuration, the step of forming the coating portion may include the third step, and the third step may include moving, in the axial direction, the nozzle injecting the coating portion (twenty-first configuration).

Example embodiments of the present disclosure are applicable to motors in each of which a surface of a stator assembly is covered with a coating portion.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator comprising:
a stator core having an annular shape surrounding a center axis extending in an axial direction and including a plurality of slots extending through the stator core in the axial direction and arranged in a circumferential direction;
a plurality of coil portions respectively provided in the plurality of slots;
a circuit board on one side of the stator core in the axial direction and electrically connected to a lead wire drawn from the plurality of coil portions; and
a coating portion having electrical insulating properties and coating at least the plurality of coil portions; wherein
the circuit board includes a first through-hole extending in the axial direction; and
at least a portion of the first through-hole overlaps the stator core as viewed in the axial direction.

2. The stator according to claim 1, wherein
at least a portion of the first through-hole overlaps at least a portion of the plurality of slots as viewed in the axial direction.

3. The stator according to claim 1, wherein
the coating portion is provided in the first through-hole.

4. The stator according to claim 1, further comprising:
a cover portion accommodating a stator assembly including the stator core, the plurality of coil portions, and the circuit board; wherein
the coating portion is between the stator assembly and the cover portion.

5. The stator according to claim 4, further comprising:
a holder having a tubular shape surrounding the center axis and extending in the axial direction and holding the stator core on an outer surface in a radial direction; wherein
the stator assembly further includes the holder.

6. The stator according to claim 4, wherein
the circuit board includes at least one recess portion of:
a first recess portion recessed inward in a radial direction at an outer end portion of the circuit board in the radial direction; or
a second recess portion recessed outward in the radial direction at an inner end portion of the circuit board in the radial direction.

7. The stator according to claim 6, wherein
the at least one recess portion overlaps at least a portion of the plurality of slots as viewed in the axial direction.

8. The stator according to claim 1, wherein
the coating portion further covers a surface of the circuit board.

9. The stator according to claim 1, wherein
the circuit board includes a connector portion connected to at least one connection wire of the lead wire or an external wiring line; and
in a circumferential direction relative to the center axis, a minimum interval in the circumferential direction between the connector portion and the first through-hole is about 45° or greater.

10. A stator comprising:
a stator core having an annular shape surrounding a center axis extending in an axial direction and including a plurality of slots extending through the stator core in the axial direction and arranged in a circumferential direction;
a plurality of coil portions respectively provided in the plurality of slots;
a coating portion having electrical insulating properties and coating at least the plurality of coil portions; and
a cover portion accommodating a stator assembly including the stator core and the plurality of coil portions; wherein
the cover portion has a lidded tubular shape that opens toward one side in the axial direction;
a second through-hole extending in the axial direction is provided in a lid portion of the cover portion; and
at least a portion of the second through-hole overlaps the stator core as viewed in the axial direction.

11. The stator according to claim 10, wherein
at least a portion of the second through-hole overlaps at least a portion of the plurality of slots as viewed in the axial direction.

12. The stator according to claim 10, wherein
the coating portion is provided in the second through-hole.

13. A motor comprising:
the stator according to claim 1; and
a rotor configured to be rotatable about the center axis.

14. A method for manufacturing a stator, the stator according to claim 1, the method comprising the steps of:
providing the circuit board such that at least a portion of the first through-hole overlaps the stator core as viewed in the axial direction; and
forming the coating portion by utilizing the first through-hole.

15. The method for manufacturing a stator according to claim 14, wherein
the step of forming the coating portion includes one of:
a first step of inserting a nozzle configured to inject the coating portion having fluidity into the first through-hole from one side of the circuit board in the axial direction and injecting the coating portion; or
a second step of pouring the coating portion having fluidity into the first through-hole from the one side of the circuit board in the axial direction; and
a step of curing the coating portion.

16. The method for manufacturing a stator according to claim 15, wherein
the step of providing the circuit board includes overlapping at least a portion of the first through-hole with the slot as viewed in the axial direction;
the step of forming the coating portion includes the first step; and
the first step includes inserting the nozzle into the slot and injecting the coating portion.

17. The method for manufacturing a stator according to claim 15, wherein
the step of forming the coating portion includes the first step; and
the first step includes moving, in the axial direction, the nozzle injecting the coating portion.

18. A method for manufacturing a stator, the stator according to claim 10, the method comprising the steps of:
providing the cover portion such that at least a portion of the second through-hole overlaps the stator core as viewed in the axial direction; and
forming the coating portion by utilizing the second through-hole.

19. The method for manufacturing a stator according to claim 18, wherein
the step of forming the coating portion includes one of:
a third step of inserting a nozzle configured to inject the coating portion having fluidity into the second through-hole from another side in the axial direction and injecting the coating portion; or
a fourth step of pouring the coating portion having fluidity into the second through-hole from another side of the cover portion in the axial direction; and
a step of curing the coating portion.

20. The method for manufacturing a stator according to claim 19, wherein
the step of providing the cover portion includes overlapping at least a portion of the second through-hole with the slot as viewed in the axial direction;
the step of forming the coating portion includes the third step; and
the third step includes inserting the nozzle into the slot and injecting the coating portion.

21. The method for manufacturing a stator according to claim 19, wherein
the step of forming the coating portion includes the third step; and
the third step includes moving, in the axial direction, the nozzle injecting the coating portion.
